(19) United States
(12) Patent Application Publication
(10) Pub. No.: US 2021/0315759 A1
(43) Pub. Date: Oct. 14, 2021

(54) POWERED SPINNING TRAINING/THERAPY APPARATUS

(71) Applicant: R & J Spinners LLC, Middletown, DE (US)

(72) Inventors: Robert J. BRICCOTTO, JR., Middletown, DE (US); Jonathan WAMPLER, Newark, DE (US)

(21) Appl. No.: 17/225,483

(22) Filed: Apr. 8, 2021

Related U.S. Application Data
(60) Provisional application No. 63/007,039, filed on Apr. 8, 2020.

(51) Int. Cl. A61H 1/00

(52) U.S. Cl. CPC A61H 1/005; A63B 26/003

(57) ABSTRACT

A powered spinning training/therapy apparatus for rotating a body of a person comprises a spinning apparatus. The spinning apparatus includes a chassis and a rotatable platform supported by the chassis for rotation about a vertical platform axis. The rotatable platform is configured to support the body of the person in an upright orientation with the vertical platform axis passing through the body of the person. A drive unit is operatively connected to the rotatable platform for rotating the rotatable platform about the vertical platform axis and has sufficient power to rotate the rotatable platform and the body of the person disposed thereon at a rotational speed of at least 0.1 RPM. A controller is provided for controlling the drive unit and thereby controlling the rotation of the rotatable platform.

### CROSS-REFERENCE TO RELATED APPLICATIONS

This application claims the benefit of priority under 35 USC § 119(e) of U.S. Provisional Patent Application No. 63/007,039 filed Apr. 8, 2020, the contents of which are incorporated into the present application by reference in their entirety.

### BACKGROUND OF THE INVENTION

The present disclosure relates generally to a system, apparatus, and method for rotating a person about a vertical rotation axis, and more particularly, to a powered spinning training/therapy apparatus for rotating a person about a vertical rotation axis, wherein the apparatus includes a rotatable platform configured so that the person may be positioned with the vertical rotation axis passing through the person's body. Such a system, apparatus, and method may be useful for exposing a user to rotational motion for therapy or training related to physical and/or neurological conditions, sports involving rotation (such as ice skating), and other activities involving rotation of a person such as atmospheric flight and space flight. Still more particularly, the training/therapy system may include a bi-directional, variable speed and/or torque drive system.

### SUMMARY OF THE INVENTION

Briefly stated, an example of a powered spinning training/therapy apparatus for rotating a body of a person comprises a spinning apparatus. The spinning apparatus includes a chassis and a rotatable platform supported by the chassis for rotation about a vertical platform axis. The rotatable platform is configured to support the body of the person in an upright orientation. A drive unit is operatively connected to the rotatable platform for rotating the rotatable platform about the vertical platform axis and has sufficient power to rotate the rotatable platform and the body of the person disposed thereon at a rotational speed of at least 0.1 RPM, or alternatively at least 0.3 RPM, or further alternatively at least 1 RPM, 5 RPM, 10 RPM, 20 RPM, 30 RPM, 100 RPM, or 200 RPM, 300 RPM, 400 RPM, or 500 RPM. Although no upper limit on rotational speed is established, depending on the intended purpose of the device, an upper rotational speed at least as high as 400 RPM is believed to be useful. A controller is provided for controlling the drive unit and thereby controlling the rotation of the rotatable platform.

In any embodiment of the spinning training/therapy apparatus, the controller may be configured for controlling the drive unit by controlling one or more of the following: a quantity of power delivered to the drive unit or to the rotatable platform; a selected rotational speed or a selected sequence of rotational speeds of the drive unit or of the rotatable platform; a clockwise and/or counterclockwise rotational direction or a sequence of clockwise and counterclockwise directions of the drive unit or of the rotatable platform.

In any embodiment of the spinning training/therapy apparatus, the controller and the drive unit may be operatively connected so that the controller may provide control signals in response to manual control and/or through programming to govern the operation of the drive unit.

In any embodiment of the spinning training/therapy apparatus, the drive unit may be operatively connected to an electric power source.

In any embodiment of the spinning training/therapy apparatus, the drive unit may be operatively connected to a non-electrical power source.

In any embodiment of the spinning training/therapy apparatus, the controller may be configured to provide a selection of at least one of a manually selected rotational speed and a selected sequence of rotational speeds and/or rotational directions of the drive unit or of the rotatable platform.

Any embodiment of the spinning training/therapy apparatus may further comprise an auxiliary controller for controlling the drive unit and thereby controlling the rotation of the rotatable platform, so that the controller and/or the auxiliary controller are configured to provide control signals in response to manual control and/or through programming to govern the operation of the drive unit.

In any embodiment of the spinning training/therapy apparatus, the auxiliary controller may be configured to provide a selection of at least one of the following: a manually selected rotational speed and/or a selected sequence of rotational speeds and/or rotational directions of the drive unit and/or of the rotatable platform.

In any embodiment of the spinning training/therapy apparatus, the controller, the auxiliary controller, and the drive unit may be operatively connected so that the controller and/or the auxiliary controller may provide control signals in response to manual control or through programming to govern the operation of the drive unit.

In any embodiment of the spinning training/therapy apparatus, the auxiliary controller may be configured to provide a selection of at least one of the following: a manually selected rotational speed and/or a selected sequence of rotational speeds and/or rotational directions of the drive unit and/or of the rotatable platform.

In any embodiment of the spinning training/therapy apparatus, the vertical platform axis may pass through a center of the rotatable platform.

In any embodiment of the spinning training/therapy apparatus, the vertical platform may be configured to support the body of the person with the vertical platform axis passing through the body of the person.

In any embodiment of the spinning training/therapy apparatus, the vertical platform may be configured to support the body of the person with the vertical platform axis passing through the body of the person.

In any embodiment of the spinning training/therapy apparatus, the controller and the drive unit may be operatively connected so that the controller may provide control signals in response to manual control and/or through programming to govern the operation of the drive unit so that the drive unit operates at a substantially continuously variable selectable range of rotational speeds wherein the range includes the rotational speed being at least 0.1 RPM.

In any embodiment of the spinning training/therapy apparatus, the controller, the auxiliary controller, and the drive unit may be operatively connected so that the drive unit operates at a substantially continuously variable selectable range of rotational speeds wherein the range includes the rotational speed being at least 0.1 RPM.

Any embodiment of the spinning training/therapy apparatus may further comprise a plurality of support wheels rotatably attached to the chassis and contacting a lower surface of the rotatable platform for supporting the rotatable platform. In any such embodiment, the chassis may have an intermediate deck below the rotatable platform, and each support wheel of the plurality of support wheels may be rotatably attached to the intermediate deck. In any such embodiment, each support wheel of the plurality of support wheels may be aligned perpendicularly with respect to a radius of the intermediate deck passing through a center of the each support wheel.

### BRIEF DESCRIPTION OF THE SEVERAL VIEWS OF THE DRAWINGS

The following detailed description will be better understood when read in conjunction with the appended drawings. For the purpose of illustrating the disclosed matter, there are shown in the drawings various embodiments, including embodiments which may be presently preferred. It should be understood, however, that the invention is not limited to the precise arrangements and instrumentalities shown. In the drawings:

FIG. 1A is a schematic view of an example of a system including a powered spinner according to the present disclosure;

FIG. 1B is a schematic view of a second example of a system including a powered spinner according to the present disclosure;

FIG. 2 is an exploded front upper perspective view of an example of a powered spinner, including the chassis thereof, according to an example of the present invention;

FIG. 3A is top plan view of a side wall of the chassis of the powered spinner of FIG. 2;

FIG. 3B is front elevational view of the side wall of FIG. 3A;

FIG. 3C is right side elevational view of a side wall of FIG. 3A;

FIG. 4 is a sectional view of the drive axle of the powered spinner of FIG. 2;

FIG. 5 is a top plan view of a top deck of the chassis of the powered spinner of FIG. 2;

FIG. 6 is a partial detail sectional view of the chassis of the powered spinner of FIG. 2;

FIG. 7 is a partial detail top plan view of the chassis of the powered spinner of FIG. 2; and

FIG. 8 is a partial detail sectional view of the chassis of the powered spinner of FIG. 2.

### DETAILED DESCRIPTION

Certain terminology is used in the following description for convenience only and is not limiting. The words “right,” “left,” “lower,” and “upper” designate directions in the drawings to which reference is made. The words “inner” and “outer” refer to directions toward and away from, respectively, the geometric center of the powered spinner and designated parts thereof. Unless specifically set forth herein, the terms “a,” “an,” and “the” are not limited to one element but instead should be read as meaning “at least one.” As used herein, the terms “proximal” and “distal” are relative terms referring to locations or elements that are closer to (proximal) or farther from (distal) with respect to other elements. The terminology includes the words noted above, derivatives thereof, and words of similar import.

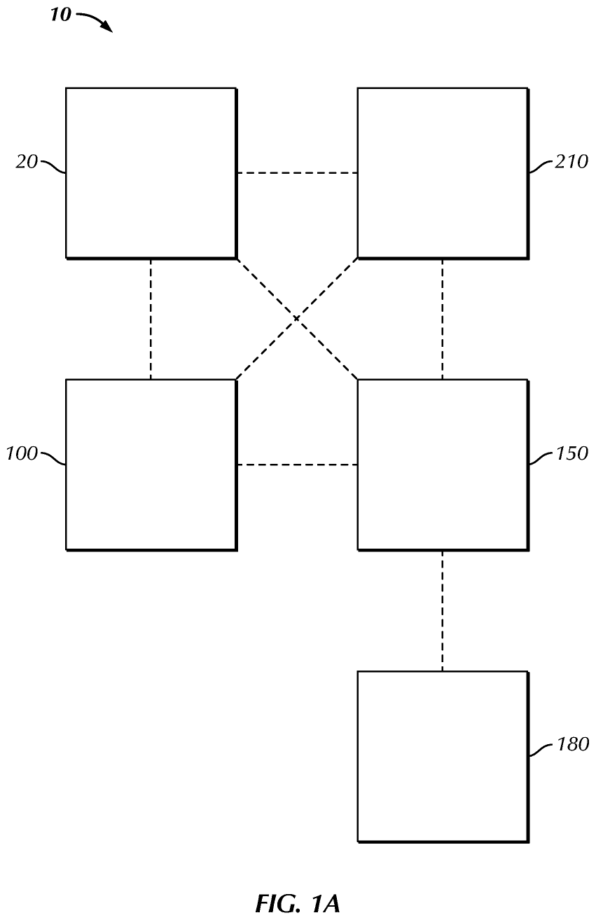

In one aspect, referring to the block diagram FIG. 1A, a powered spinning training/therapy apparatus 10 is disclosed for rotating a body of a person. The powered spinning training/therapy apparatus 10 comprises a spinning apparatus 20, a drive unit 210, and a controller 100. The powered spinning training apparatus 10 shown in FIG. 1A may include an auxiliary controller 150; details of examples of auxiliary controllers 150 are discussed below. As shown in FIG. 1A, each of the spin apparatus 20, the drive unit 210, the controller 100, and the auxiliary controller 150 (where present) may be operatively connected, directly or through an intervening component, to one, two, or three of the other components as indicated by dashed lines connecting the blocks indicating each component. For example, a power supply 180 is operatively connected directly to the auxiliary controller 150 and is connected to the drive unit 210 through the intervening auxiliary controller 150. The controller 100, the auxiliary controller 150, and the drive unit 210 are operatively connected so that the controller 100 and/or the auxiliary controller 150 may provide control signals in response to manual control or through programming to govern the operation of the drive unit 210. The drive unit 210 preferably has sufficient power to rotate the rotatable platform and the body of the person disposed thereon at a rotational speed of at least at a rotational speed of at least 0.1 RPM, or alternatively at least 0.3 RPM, or further alternatively at least 1 RPM, 5 RPM, 10 RPM, 20 RPM, 30 RPM, 100 RPM, or 200 RPM, 300 RPM, 400 RPM, or 500 RPM. Although no upper limit on rotational speed is firmly established, depending on the intended purpose of the device, an upper rotational speed as low as 10 RPM, or as high as 400 RPM, are believed to be useful. The controller 100, the auxiliary controller 150, and the drive unit 210 may be operatively connected so that the drive unit 210 operates at a substantially continuously variable selectable range of rotational speeds wherein the range includes the rotational speed being at least 0.1 RPM. Here “substantially continuously variable” means a continuously variable rotational speed range (as might be available under linear control by, for example, a potentiometer), or a selectable variable rotational speed range that allows at least 5, 10, 20, or more selectable rotational speeds (as in, for example, a digital controller allowing change of the rotational speed by 0.1 RPM, 1 RPM, or by a plurality of variable increments).

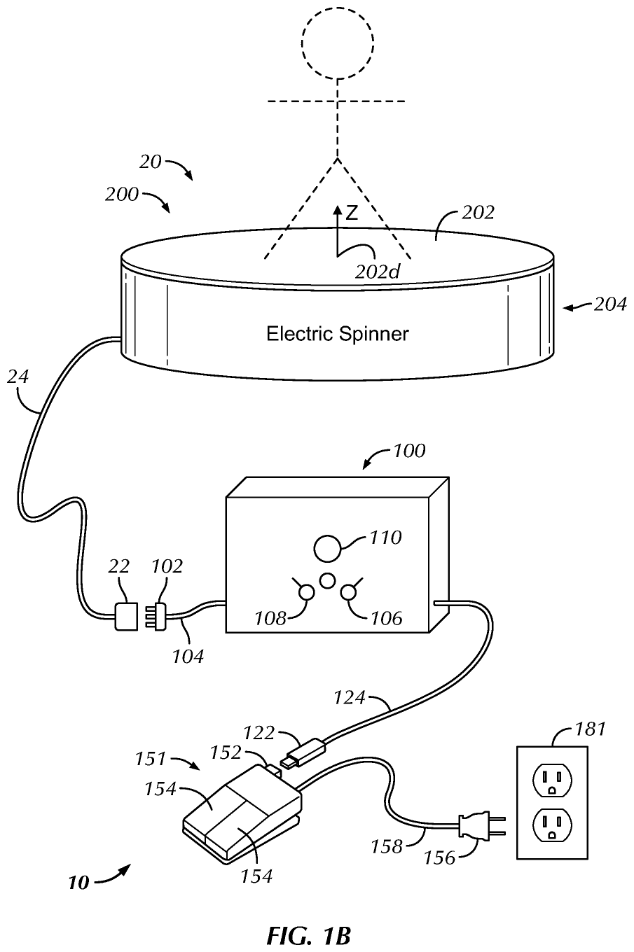

In another aspect, referring to FIGS. 1B and 2, disclosed herein is another example of a powered spinning training/therapy apparatus 10 including a spinning apparatus 20 for rotating a person (shown schematically in FIG. 2) about a vertical rotation axis Z. The powered spinning training/therapy system 10 may comprise the spinning apparatus 20, a spinner controller 100, and the drive unit 210, which is housed inside of a chassis 200. Optionally, the powered spinning training/therapy system 10 may include an auxiliary controller, such as a foot controller 151 (FIG. 1B), and control and/or power connections between the spinning apparatus 20 and the spinner controller 100, the foot controller 151 (where present), and a power source in the form of a standard wall outlet such as a standard voltage electrical power receptacle 181.

The spinning apparatus 20 is preferably electrically powered, but the power supply 180 (FIG. 1A) may be powered by other means such as gas engines, hydraulic or pneumatic drives, power take-offs and the like. The power supply 180 need not be physically separated from the drive unit 210 (FIG. 1A); in particular, electrical power sources may be suited to being integrated into the chassis 200 and/or the electric motor 212 (FIG. 2). The spinning apparatus 20 may be connectable to the spinner controller 100 by any of several types of connectors, such as wired connections and wireless connections (Bluetooth, Wi-Fi, I2C, universal serial bus (USB), RS232/RS485, radio signals, and other such connections known in the art). Likewise, the spinner controller 100 may be coupled to the spinning apparatus 20, the auxiliary controller 150, or other devices, such as a remote control (not shown) via wired and/or wireless communications mediums.

The auxiliary controller 150 may be at least one of any number of remote control devices such as a hand-operated controller, a foot-operated controller such as the foot controller 151, a remote controller, a tablet, a smartphone, a personal computer, or the like.

As illustrated in FIG. 1B, a preferred embodiment of the present invention is shown as being electrically powered. The spinning apparatus 20 is connectable to the spinner controller 100 by a wired connection including an input receptacle 22 and a spinner-input wiring 24 of the spinning apparatus 20. The spinner controller 100 is configured to the control direction of rotation, as well as speed and/or torque of the drive unit 210 and/or the electric motor 212. The spinner controller 100 may have a output plug 102, which may be connectable to the input receptacle 22 of the spinning apparatus 20. The spinner controller 100 and the auxiliary controller 151 may be powered by a battery or other power supply (not shown). In the illustrated embodiment, the output plug 102 is connectable to the remainder of the spinner controller 100 by spinner-controller-output wiring 104. The spinner controller 100 also has an input plug 122 connectable by spinner-controller-input wiring 124. In the illustrated embodiment, the spinner controller 100 controls the spinning apparatus 20 by delivering regulated or controlled power to the spinning apparatus 20 according to user input to the spinner controller 100, and/or programming thereof. The spinner controller 100 may include circuitry such as a soft start, a variable frequency controller, a variable voltage/current/power controller, a variable resistance controller, or the like. The spinner controller 100 may also include a microcontroller, a programmable logic array (PLA), an application specific integrated circuit (ASIC), a microprocessor, a programmable logic controller (PLC), relay ladder logic, logic circuits and the like as would be readily understood by those skilled in the art. The input plug 122 is connectable to an output receptacle 152 of the foot controller 151. The foot controller 151 has two footpads 154 but may have only one footpad 154, or additional footpads 154, as needed to enable the user to select desired control inputs to the foot controller 151. The foot controller 151 has a power plug 156 and a power-supply wiring 158 for connecting to a power outlet 180; but these components may be replaced by connections to alternative power sources as discussed above. The plugs and receptacles described herein are examples and may be replaced with alternative known combinations of connectors.

The components described herein constitute one example of a system for operating the spinning apparatus 20. Other arrangements are possible, provided that the system includes a powered spinner; a spinner controller; a means for obtaining user input, such as one or more switches, buttons, knobs, touch pads, screens, pressure sensors, microphones, a remote control, a tablet, a personal computer, or the like; and a means for converting the user input into signals for controlling the powered spinner.

The spinning apparatus 20 may include, or may be connected to, an electrical or mechanical drive unit supplying torque and power to a rotatable platform 202 of the spinning apparatus 20. The details of an example of a spinning apparatus 20 will be discussed below. If the power supply for the drive unit 210 of the spinning apparatus 20 is electrical, the necessary electrical power for the drive unit 210 may be supplied by any suitable source—for example, a battery, a solar electric supply, a generator, a commercial electrical supply, etc. If the power supply for the drive unit 210 of the spinning apparatus 20 is not electrical, the power supply may include an energy-storage system such as a spring or similar device, a pneumatic system powering the drive unit 210 by means of pressurized gas, or a hydraulic system powering the drive unit 210 by means of a pressurized fluid.

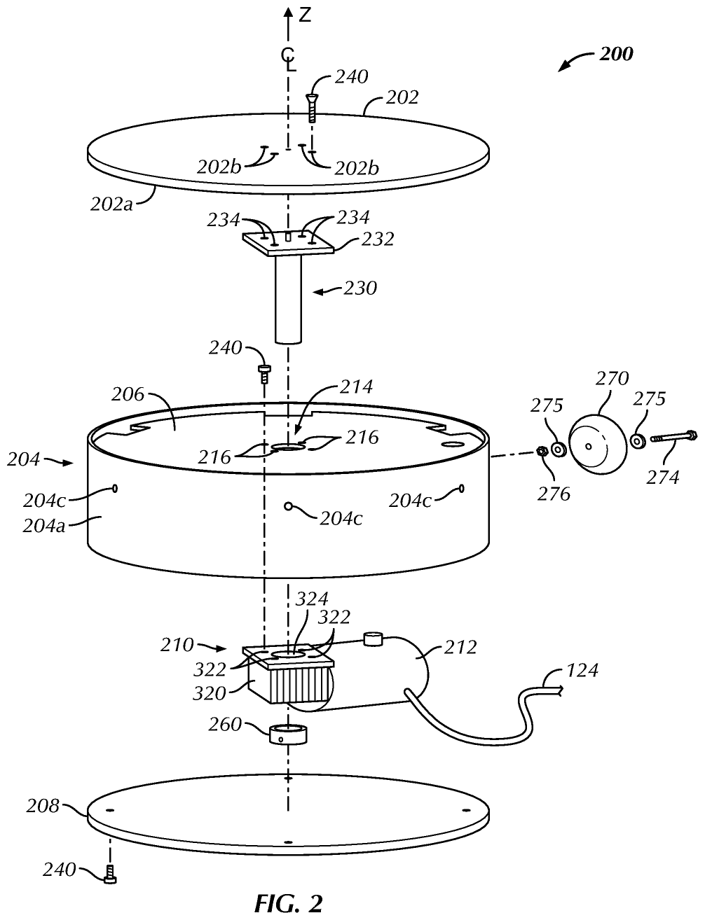

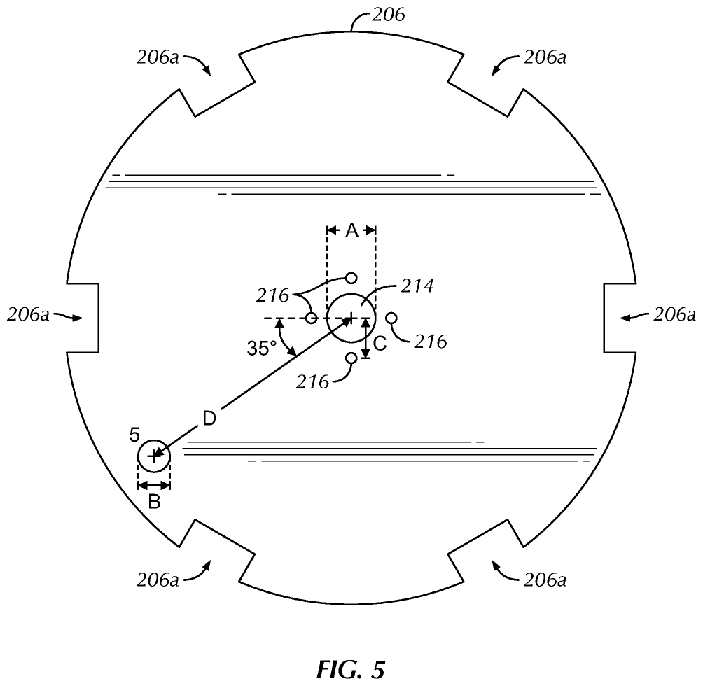

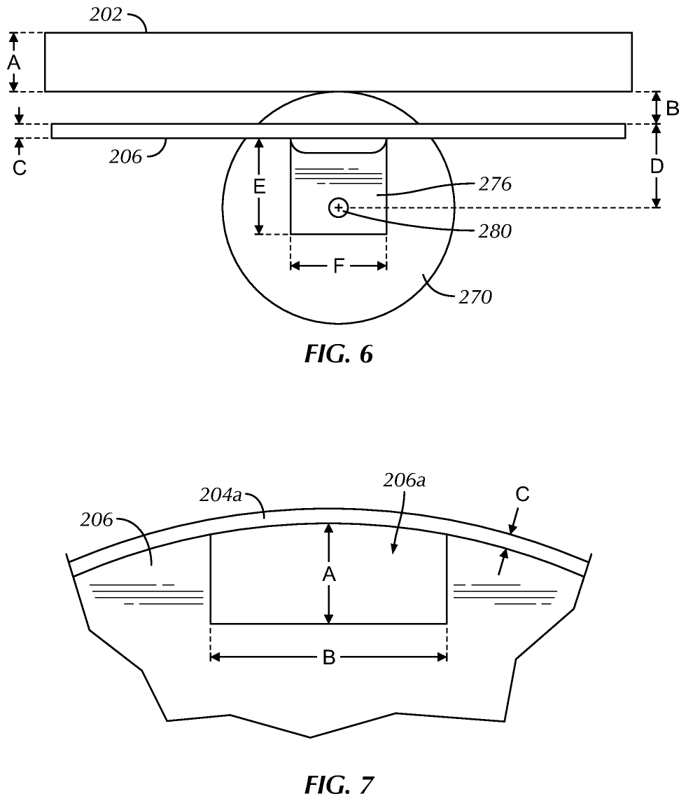

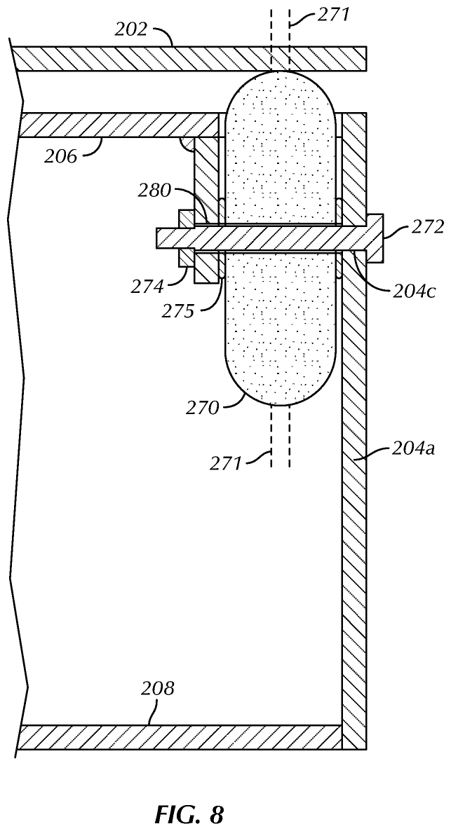

Referring to FIGS. 2 through 8, the spinning apparatus 20 may include a chassis 200 with a rotatable platform 202, which may be used to support and rotate a human user (shown schematically) about a vertical rotation axis (which in the depicted embodiment coincides with a vertical platform axis Z), which in the illustrated embodiment passes through the center of, and corresponds to a center line CL of, the rotatable platform 202. A spinning apparatus 20 may include a chassis 200 and a rotatable platform 202 supported by the chassis 200 for rotation about the vertical platform axis Z passing through a center of the rotatable platform, the rotatable platform 202 being configured to support the body of the person in an upright orientation with the vertical platform axis Z passing through the body of the person.

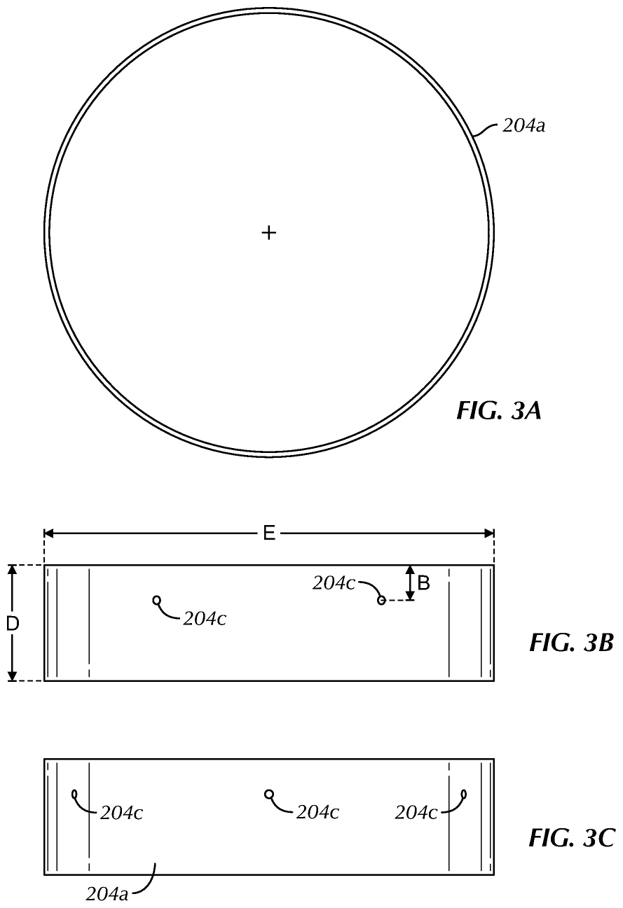

The rotatable platform 202 may be made of any suitably strong and stiff material and may preferably be made from a strong, relatively lightweight material such as aluminum. Referring to FIG. 4, the chassis 200 may include a drive axle 230 with a drive shaft 231, with the drive shaft 231 having a mounting plate 232 attached to the upper portion thereof. The mounting plate 232 may be attached to the drive shaft 231 by any suitable means, such as a weld 238, fasteners, adhesives, threads, or the like. The mounting plate 232 may have a central aperture 232a accommodating a dowel 236, which may aid in alignment of a central aperture 202c of the rotatable platform 202 with the central aperture 232a. The rotatable platform 202 may have mounting holes 202b that may be aligned with mounting holes 234 of the mounting plate 232. Screws 240 may pass through the mounting holes 202b of the rotatable platform 202, and through the mounting holes 234 of the mounting plate 232, to secure the rotatable platform 202 to the mounting plate 232. The rotatable platform 202 may be secured to the mounting plate 232 in any suitable fashion, including by screws, bolts, and the like. The mounting plate 232 need not necessarily be square and may be any suitable shape. It is contemplated that the drive shaft 231 may be coupled to a transmission or gear box (not shown) in order to control speed and/or torque mechanically as well.

The chassis 200 may further comprise a side wall 204, an intermediate deck 206 supported by the side wall 204, and a lower dust plate 208. The side wall 204 may comprise a side wall panel 204a, and may form an exterior portion of the chassis 200. The side wall 204 includes side wall-axle mounting holes 204c near an upper portion thereof and lower-deck mounting holes 204d near a lower portion thereof. The functions of the mounting holes 204c, 204d are explained below. The intermediate deck 206, and the lower deck 300 and the lower dust plate 208 where present, together with the side wall 204, may enclose an interior space of the chassis 200. A mounting ring (not shown) may be welded or otherwise secured inside the inside the side wall panel 204a, with matching threaded holes for attaching the dust cover 208 to the chassis 202. A drive unit 210 with an electric motor 212 may be enclosed within the interior space within the chassis 200 and may be fixed directly or indirectly to one or more of the side wall 204, the lower deck 300, the lower dust plate 208, or the intermediate deck 206. As best seen in FIG. 2, in the illustrated embodiment, the drive unit 210 includes an electric motor 212. The drive unit 210 preferably has sufficient power to rotate the rotatable platform and the body of the person disposed thereon at a rotational speed of at least 0.1 RPM. A drive unit mounting block 320 is attached to the electric motor 212 and includes mounting holes 322 surrounding a shaft aperture 324. In an assembled condition, the drive shaft 231 passes through the shaft aperture 324 of the drive unit mounting block 320, and fasteners such as screws 220, 240 engage the mounting holes 322 of the drive unit mounting block 320 and drive-unit-mounting holes 216 of the intermediate deck 206 to secure the drive unit 210 to the intermediate deck 206. Each chassis component may be made from any suitably strong and stiff material and may preferably be made from steel, aluminum, or other metallic materials.

The drive unit 210 may engage the drive axle 230 with a mounting plate 232 attached thereto. A locking collar 260 may engage a lower end 234 of the drive axle 230 to limit or prevent upward axial movement thereof. The drive axle 230 may be positioned so that the mounting plate 232 is located above the intermediate deck 206 in spaced relation thereto, with the drive axle 230 extending downwardly through a central aperture 214 of the intermediate deck 206.

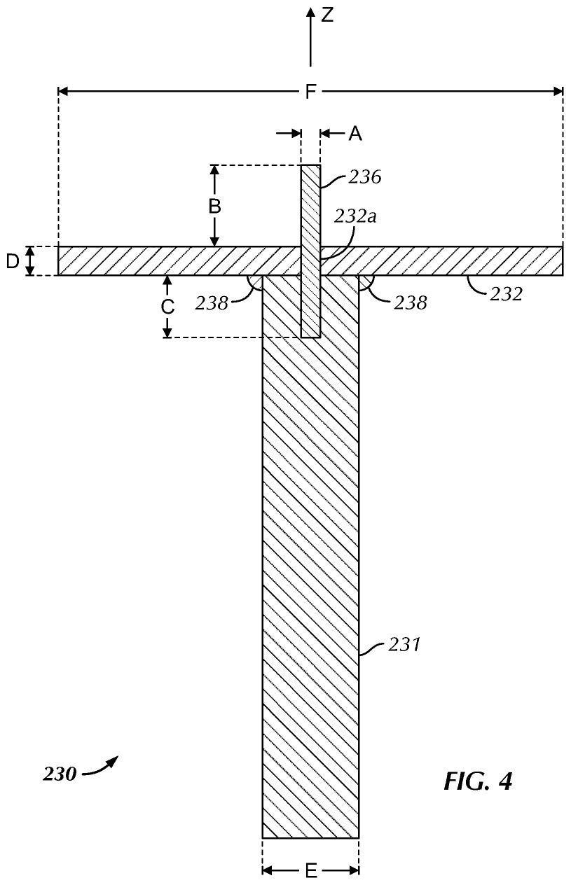

Referring to FIGS. 5 through 8, the intermediate deck 206 may have a plurality of wheel notches 206a disposed about a perimeter thereof. In each notch, a support wheel 270 may be aligned perpendicularly with respect to a radius of the intermediate deck passing through a center of the support wheel 270 and may be attached to the chassis 200 by an axle carriage bolt 272 and a corresponding axle carriage nut 274. Each support wheel 270 may have a rounded contact surface 271 so that only a narrow portion of the support wheel 270 makes contact with the lower surface 202a of the rotatable platform 202. The contact surface of the support wheel 270 may be made from wood, cardboard, rubber, metal, polymeric materials such as plastic, particle board, or other suitable material. In the embodiment illustrated, six wheel notches 206a are disposed essentially equidistantly about the perimeter of the intermediate deck 206. Each wheel notch 206a includes a downwardly extending axle tab 276 attached to the intermediate deck 206 and located radially inwardly from the outer edge of the intermediate deck 206. The axle tab 276 may be attached to the intermediate deck 206 by means of a weld 278 or other suitable attachment, including but not limited to being integrally formed with the intermediate deck 206. The axle tab 276 has an axle hole 280 for attachment of the support wheel 270 to the intermediate deck 206 and the side wall 204 in the wheel notch 206a by means of the axle carriage bolt 272, the axle carriage nut 274, the axle tab 276, and the side wall-axle mounting hole 204c. Washers 275 may be disposed between each support wheel 270 and the axle tab 276, and between each support wheel 270 and one of the side wall panel 204a of the side wall.

Referring to FIGS. 2 and 6 through 8, the chassis 200 in the illustrated embodiment thus includes a plurality of support wheels 270 for supporting the rotatable platform 202 in spaced relation to the intermediate deck 206, in a manner having a low degree of resistance to rotation. Each support wheel 270 may be rotatably attached to the chassis 200 and may contact a lower surface 202a of the rotatable platform 202. In this manner, the plurality of support wheels 270 (six support wheels 270 are shown) may together bear the downward load of the weight of the payload and the rotatable platform 202.

The drive unit 210 alternatively may be external to the chassis 200 and may be operatively connected to rotate the rotatable platform 202 by means of an alternative mechanism, such as an offset friction drive system with a wheel driving the rotatable platform 202 through contact with a top or bottom surface of the rotatable platform 202; a pulley system operatively connected to the drive axle 230 or operatively connected to a driven pulley rotationally coupled to the rotatable platform 202; a gear drive operatively connected to the rotatable platform 202; a magnetic induction drive system operatively connected to the rotatable platform 202; or any other suitable mechanism for driving the rotatable platform 202 in a controlled manner.

The drive unit 210 may supply torque and power to drive the rotatable platform 202 in counterclockwise or clockwise rotation based on the input thereto from the spinner controller 100 and/or the auxiliary controller 150/foot controller 151 (if present). The spinner controller 100 may be configured for controlling the drive unit 210 by controlling one or more of the following: an quantity of power delivered to the drive unit 210 or to the rotatable platform 202; a selected rotational speed or a selected sequence of rotational speeds of the drive unit 210 or of the rotatable platform 202; a clockwise and/or counterclockwise rotational direction or a sequence of clockwise and counterclockwise directions of the drive unit 210 or of the rotatable platform 202. The drive unit 210 may be controlled or programmed to provide a variety of set rotational speeds and to control a rotational acceleration profile—that is, to control how the rotational speed of the rotatable platform 202 varies over time. For example, a user might select a smooth, gentle acceleration profile from stopped to a particular rotation speed; alternatively, a user might select a more rapid acceleration profile due to the user's capacity to tolerate the same. The rotatable platform 202 and any connected hardware such as the drive unit 210 may allow the rotatable platform 202 to rotate freely while not being driven by the drive unit 210. Alternatively, the rotatable platform 202 and any connected hardware such as the drive unit 210 may be configured so that the rotatable platform 202 comes to a stop and is immobilized, or essentially immobilized, and requires relatively high torque to be moved, when not being driven by the drive unit 210. Further alternatively, the rotatable platform 202 and any connected hardware may be selectable either to rotate freely when not driven by the rotatable platform 202, or to be immobilized or essentially immobilized when not driven by the rotatable platform 202.

The spinner controller 100 may be used to set and control the rate of rotation and the direction of rotation of the rotatable platform 202. The spinner controller 100 may be located outside the chassis 200 (as depicted in FIG. 1) or may be located within the chassis 200. The spinner controller 100 may include controls such as a three-position switch 106 (which may have off, forward, and reverse positions for controlling the direction of rotation), a variable-output switch 108, or other controls allowing manual setting of the rate and direction of rotation; or the spinner controller 100 may be programmable to provide appropriate output for a series of selected rates of rotation and direction of rotation of the rotatable platform 202. The spinner controller 100 may have a display 110 such as a dial, series of lights, or screen showing the applicable spinner settings or program. Although the spinner controller 100 is operatively connected to the drive unit 210 by wiring in FIG. 1, the spinner controller 100 may be operatively connected to the drive unit 210 via wireless connections such as Bluetooth, Wi-Fi, infrared, ultrasonic, or radio signals.

The auxiliary controller in the form of the foot controller 151 is an optional component. Any auxiliary controller 150 may include the components and features described above with respect to the controller 100. Where the auxiliary controller/foot controller 151 is absent, the spin controller 150 may be connected directly to a power source, such as a wall outlet 150. The foot controller 151 may have one or more footpads 154 for providing input to the foot controller 151, thus providing the user or operator a hands-free method for controlling the device. The footpads 154 may be configured to allow a user or operator to start and stop the rotatable platform 202, or to vary the speed and direction of rotation of the rotatable platform 202, or to control any combination of inputs affecting the behavior of the rotatable platform 202. In an alternative embodiment, the auxiliary controller/foot controller 151 may be combined in a single unit with the spinner controller 100. The controller 100, the auxiliary controller 150 (such as the foot controller 151), power supply 180/wall outlet 181, and the drive unit 210/electric motor 212 may be operatively connected so that the controller 100 and/or the auxiliary controller 150 in combination may provide control signals in response to manual control or through programming to govern the operation of the drive unit 210 and/or electric motor 212 and thus the operation of the rotatable platform 202.

The entire spinning training/therapy system 10 may be provided with a specialized cart or hand truck for convenient transport thereof. One or more components of the system 10 may be more or less permanently attached to the cart or hand truck.

Devices according to the present disclosure may be used as, or as part of, a training device or method for athletes in sports where spin rotation about a vertical rotation axis is an integral part of the sport (i.e., figure skating, dance, ballet, gymnastics, basketball, football, hockey, baseball, and the like).

Devices according to the present disclosure may be used as, or as part of, a therapeutic treatment device, system and/or method for autistic individuals where rotation in the longitudinal axis provides a therapeutic benefit.

Devices according to the present disclosure may be used as, or as part of, a therapeutic treatment device, system, and/or method for patients suffering from vestibular/balance disease where rotation about the longitudinal vertical axis provides a therapeutic benefit.

Devices according to the present disclosure may be used as, or as part of, a therapeutic treatment device, system and/or method for patients suffering from Traumatic Brain Injury (TBI) where rotation in the longitudinal axis provides therapeutic treatment for cases of concussion recovery, TBIB (Traumatic Brain Injury, Blunt), and TBIE (Traumatic Brain Injury, Explosive).

Devices according to the present disclosure may be used as, or as part of, training device or method for brain training and exercise benefit, to be used in the course of a physical fitness training program for lifelong health and wellness.

Devices according to the present disclosure may be used as, or as part of, training device or method for disorientation training for professions that require an individual to effectively accomplish tasks while suffering from conflicting balance senses—for example, pilots, high crane operators etc.

Methods of performing spin training and/or therapy according to the present disclosure may include the following:
positioning a body of a user in a working position on powered spinning training/therapy apparatus, the powered spinning training/therapy apparatus comprising a spinning apparatus including a chassis and a rotatable platform supported by the chassis for rotation about a vertical platform axis, the rotatable platform being configured to support the body of the person in an upright orientation, with the spinning apparatus including a drive unit operatively connected to the rotatable platform for rotating the rotatable platform about the vertical platform axis, the drive unit having sufficient power to rotate the rotatable platform and the body of the person disposed at a rotational speed of at least 0.1 RPM and/or as otherwise disclosed herein, and with the spinning apparatus including a controller for controlling the drive unit and thereby controlling the rotation of the rotatable platform; and
operating the drive unit to rotate the body of the user.

Methods of performing spin training and/or therapy according to the present disclosure may include the powered spinning training/therapy apparatus including any elements or combination of elements disclosed herein, including but not limited to the following examples.

Methods of performing spin training and/or therapy according to the present disclosure may include the vertical platform axis passing through a center of the rotatable platform. Methods of performing spin training and/or therapy according to the present disclosure may include the vertical platform being configured to support the body of the person with the vertical platform axis passing through the body of the person.

Methods of performing spin training and/or therapy according to the present disclosure may include the spinning apparatus having a controller configured for controlling the drive unit by controlling one or more of the following controlled quantities and/or rotational directions: a quantity of power delivered to the drive unit or to the rotatable platform; a selected rotational speed or a selected sequence of rotational speeds of the drive unit or of the rotatable platform; a clockwise and/or counterclockwise rotational direction or a sequence of clockwise and counterclockwise directions of the drive unit or of the rotatable platform, and the step of operating the controller including providing inputs governing at least one of the controlled quantities and/or rotational directions. Methods of performing spin training and/or therapy according to the present disclosure may include the controller and the drive unit being operatively connected so that the controller may provide control signals in response to manual control and/or through programming to govern the operation of the drive unit. Methods of performing spin training and/or therapy according to the present disclosure may include the drive unit being operatively connected to an electric power source or a non-electrical power source.

Methods of performing spin training and/or therapy according to the present disclosure may include the controller being configured to provide a selection of at least one of a manually selected rotational speed and a selected sequence of rotational speeds and/or rotational directions of the drive unit or of the rotatable platform.

Methods of performing spin training and/or therapy according to the present disclosure may include the spinning apparatus comprising an auxiliary controller for controlling the drive unit and thereby controlling the rotation of the rotatable platform, so that the controller and/or the auxiliary controller are configured to provide control signals in response to manual control and/or through programming to govern the operation of the drive unit. Methods of performing spin training and/or therapy according to the present disclosure may include the step of operating the auxiliary controller including providing inputs governing at least one of the controlled quantities and/or directions. Methods of performing spin training and/or therapy according to the present disclosure may include the auxiliary controller being configured to provide a selection of at least one of the following: a manually selected rotational speed and/or a selected sequence of rotational speeds and/or rotational directions of the drive unit and/or of the rotatable platform. Methods of performing spin training and/or therapy according to the present disclosure may include the controller, the auxiliary controller, and the drive unit being operatively connected so that the controller and/or the auxiliary controller may provide control signals in response to manual control or through programming to govern the operation of the drive unit.

Devices according to the present disclosure may be used as, or as part of, devices or methods for other purposes as well.

It will be appreciated by those skilled in the art that changes could be made to the embodiments described above without departing from the broad inventive concept thereof. It is understood, therefore, that this invention is not limited to the particular embodiment disclosed, but it is intended to cover modifications within the spirit and scope of the present invention as defined by the appended claims.

1. A powered spinning training/therapy apparatus for rotating a body of a person, the powered spinning training/therapy apparatus comprising:
a spinning apparatus including a chassis and a rotatable platform supported by the chassis for rotation about a vertical platform axis, the rotatable platform being configured to support the body of the person in an upright orientation;
a drive unit operatively connected to the rotatable platform for rotating the rotatable platform about the vertical platform axis, the drive unit having sufficient power to rotate the rotatable platform and the body of the person disposed thereon at a rotational speed of at least 0.1 RPM; and
a controller for controlling the drive unit and thereby controlling the rotation of the rotatable platform.

2. The spinning training/therapy apparatus according to claim 1, wherein the controller is configured for controlling the drive unit by controlling one or more of the following: a quantity of power delivered to the drive unit or to the rotatable platform; a selected rotational speed or a selected sequence of rotational speeds of the drive unit or of the rotatable platform; a clockwise and/or counterclockwise rotational direction or a sequence of clockwise and counterclockwise directions of the drive unit or of the rotatable platform.

3. The powered spinning training/therapy apparatus according to any preceding claim, wherein the controller and the drive unit are operatively connected so that the controller may provide control signals in response to manual control and/or through programming to govern the operation of the drive unit.

4. The powered spinning training/therapy apparatus according to any preceding claim, wherein the drive unit is operatively connected to an electric power source.

5. The powered spinning training/therapy apparatus according to any preceding claim, wherein the drive unit is operatively connected to a non-electrical power source.

6. The powered spinning training/therapy apparatus according to any preceding claim, wherein the controller is configured to provide a selection of at least one of a manually selected rotational speed and a selected sequence of rotational speeds and/or rotational directions of the drive unit or of the rotatable platform.

7. The powered spinning training/therapy apparatus according to any preceding claim, further comprising an auxiliary controller for controlling the drive unit and thereby controlling the rotation of the rotatable platform, so that the controller and/or the auxiliary controller are configured to provide control signals in response to manual control and/or through programming to govern the operation of the drive unit.

8. The powered spinning training/therapy apparatus according to claim 7, wherein the auxiliary controller is configured to provide a selection of at least one of the following: a manually selected rotational speed and/or a selected sequence of rotational speeds and/or rotational directions of the drive unit and/or of the rotatable platform.

9. The powered spinning training/therapy apparatus according to claim 7, wherein the controller, the auxiliary controller, and the drive unit are operatively connected so that the controller and/or the auxiliary controller may provide control signals in response to manual control or through programming to govern the operation of the drive unit.

10. The powered spinning training/therapy apparatus according to claim 9, wherein the auxiliary controller is configured to provide a selection of at least one of the following: a manually selected rotational speed and/or a selected sequence of rotational speeds and/or rotational directions of the drive unit and/or of the rotatable platform.

11. The powered spinning training/therapy apparatus according to any preceding claim, wherein the vertical platform axis passes through a center of the rotatable platform.

12. The powered spinning training/therapy apparatus according to any preceding claim, wherein the vertical platform is configured to support the body of the person with the vertical platform axis passing through the body of the person.

13. The powered spinning training/therapy apparatus according to claim 11, wherein the vertical platform is configured to support the body of the person with the vertical platform axis passing through the body of the person.

14. The powered spinning training/therapy apparatus according to claim 3, wherein the controller and the drive unit are operatively connected so that the controller may provide control signals in response to manual control and/or through programming to govern the operation of the drive unit so that the drive unit operates at a substantially continuously variable selectable range of rotational speeds wherein the range includes the rotational speed being at least 0.1 RPM.

15. The powered spinning training/therapy apparatus according to claim 7, wherein the controller, the auxiliary controller, and the drive unit are operatively connected so that the drive unit operates at a substantially continuously variable selectable range of rotational speeds wherein the range includes the rotational speed being at least 0.1 RPM.

16. The powered spinning training/therapy apparatus according to any preceding claim, further comprising a plurality of support wheels rotatably attached to the chassis and contacting a lower surface of the rotatable platform for supporting the rotatable platform.

17. The powered spinning training/therapy apparatus according to claim 16, wherein the chassis has an intermediate deck below the rotatable platform, and each support wheel of the plurality of support wheels is rotatably attached to the intermediate deck.

18. The powered spinning training/therapy apparatus according to claim 17, wherein each support wheel of the plurality of support wheels is aligned perpendicularly with respect to a radius of the intermediate deck passing through a center of the each support wheel.
